(19) United States
(12) Patent Application Publication
(10) Pub. No.: US 2026/0220366 A1
(43) Pub. Date: Jul. 30, 2026

(54) METHOD AND APPARATUS FOR DETECTING DATA ACQUISITION EXPLICIT INDICATION IN APPLICATION, DEVICE, PRODUCT

(71) Applicant: Beijing Zitiao Network Technology Co., Ltd., Beijing (CN)

(72) Inventor: Shuai Li, Beijing (CN)

(21) Appl. No.: 19/458,677

(22) Filed: Jan. 23, 2026

(30) Foreign Application Priority Data
Jan. 26, 2025 (WO) PCT/CN2025/075319

(51) Int. Cl. G06F 40/279; G06F 21/62; G06F 40/30; G06F 40/40

(52) U.S. Cl. CPC G06F 40/279; G06F 21/6245; G06F 40/30; G06F 40/40

(57) ABSTRACT

The present disclosure relates to a method and apparatus for detecting an information acquisition explicit indication, a device, and a product. The method includes determining that the application acquires target data. The method further includes acquiring page information on a runtime page in the application. The method further includes generating, based on the page information, an explicit indication recognition result using a language model, the explicit indication recognition result indicates whether the page information includes the explicit indication for data acquisition. Additionally, the method further includes determining, based on the target data and the explicit indication recognition result, whether the acquisition of the target data meets predetermined requirements. Through the method, the accuracy of recognizing the explicit indication for data acquisition can be improved, and the comprehensiveness of detecting the explicit indication for data acquisition can also be improved.

### CROSS-REFERENCE TO RELATED APPLICATION(S)

This application claims priority to PCT Application No. PCT/CN2025/075319 filed on Jan. 26, 2025, the disclosure of which is incorporated herein by reference in its entity.

### FIELD

The present disclosure relates to the field of data security, and more specifically, to a method and apparatus for detecting an explicit indication for data acquisition in an application, a device, a product.

### BACKGROUND

As awareness of people for data protection continues to increase, users are paying closer attention to how applications collect and process specific categories of target data. Therefore, there are regulations and requirements for the acquisition of such target data, which emphasize the importance of safeguarding users'right to know. Mobile applications, as technology carriers deeply integrated into various aspects of lives and work of people, carry a large amount of target data, and therefore become a key object that cannot be ignored in the governance of protecting users' right to know.

An explicit indication for data acquisition refers to clearly informing the users in the applications about the target data that needs to be acquired and the purpose for acquiring the data, and obtaining the consent of the users, which is a transparent data processing mechanism, and is intended to provide the users with a full understanding of the acquisition and use of the target data.

### SUMMARY

According to a first aspect of embodiments of the present disclosure, a method for detecting an explicit indication for data acquisition in an application is provided. The method includes determining that the application acquires target data. The method further includes acquiring page information on a runtime page in the application. The method further includes generating, based on the page information, an explicit indication recognition result using a language model, the explicit indication recognition result indicates whether the page information includes the explicit indication for data acquisition. Additionally, the method further includes determining, based on the target data and the explicit indication recognition result, whether the acquisition of the target data meets predetermined requirements.

According to a second aspect of the embodiments of the present disclosure, an apparatus for detecting an explicit indication for data acquisition in an application is provided. The apparatus includes an acquisition action determination module, configured to determine that the application acquires target data. The apparatus further includes a page information acquisition module, configured to acquire page information on a runtime page in the application. The apparatus further includes an explicit indication recognition module, configured to generate, based on the page information, an explicit indication recognition result using a language model, the explicit indication recognition result indicates whether the page information includes the explicit indication for data acquisition. Additionally, the apparatus further includes an explicit indication detection module, configured to determine, based on the target data and the explicit indication recognition result, whether the acquisition of the target data meets predetermined requirements.

According to a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for detecting an explicit indication for data acquisition in an application. The method includes determining that the application acquires target data. The method further includes acquiring page information on a runtime page in the application. The method further includes generating, based on the page information, an explicit indication recognition result using a language model, the explicit indication recognition result indicates whether the page information includes the explicit indication for data acquisition. Additionally, the method further includes determining, based on the target data and the explicit indication recognition result, whether the acquisition of the target data meets predetermined requirements.

According to a fourth aspect of the embodiments of the present disclosure, a computer program product is provided. The computer program product is tangibly stored on a non-transitory computer-readable medium and includes a machine-executable instruction, and the machine-executable instruction, when executed, causes a machine to implement a method for detecting an explicit indication for data acquisition in an application. The method includes determining that the application acquires target data. The method further includes acquiring page information on a runtime page in the application. The method further includes generating, based on the page information, an explicit indication recognition result using a language model, the explicit indication recognition result indicates whether the page information includes the explicit indication for data acquisition. Additionally, the method further includes determining, based on the target data and the explicit indication recognition result, whether the acquisition of the target data meets predetermined requirements.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in combination with the accompanying drawings and with reference to following detailed descriptions. In the accompanying drawings, the same or similar reference numerals denote the same or similar elements.

FIG. 1 illustrates a schematic diagram of an example environment where a plurality of embodiments of the present disclosure may be implemented;

FIG. 2 illustrates a flowchart of a method for detecting an explicit indication for data acquisition in an application according to some embodiments of the present disclosure;

FIG. 3 illustrates a schematic diagram of an architecture of an example system for detecting an explicit indication for data acquisition in an application according to some embodiments of the present disclosure;

FIG. 4 illustrates a schematic diagram of an example for generating a prompt allowing a language model to output an explicit indication recognition result according to some embodiments of the present disclosure;

FIG. 5 illustrates a schematic diagram of an example for generating a prompt allowing a language model to output an explicit indication component according to some embodiments of the present disclosure;

FIG. 6 illustrates a schematic diagram of an example for training a language model for outputting an explicit indication recognition result according to some embodiments of the present disclosure;

FIG. 7 illustrates a schematic diagram of an example for training a language model for outputting an explicit indication component according to some embodiments of the present disclosure;

FIG. 8 illustrates a block diagram of an apparatus for detecting an explicit indication for data acquisition in an application according to some embodiments of the present disclosure; and

FIG. 9 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, namely, “including but not limited to”. The term “based on” should be understood as “at least partially based on”. The term “an embodiment” or “this embodiment” should be understood as “at least one embodiment”. The terms “first”, “second”, etc. may refer to different or identical objects, unless otherwise explicitly specified. Other explicit and implicit definitions may also be included below.

Currently, a mobile application primarily relies on a separate data acquisition statement document (e.g., a privacy policy document) to inform the user about a scope, a method, and a purpose of collecting and processing target data. Therefore, existing detection solutions for safeguarding users' right to know focus on detecting whether the statement document of the mobile application meets predetermined requirements.

However, the user often ignores or skims through the data acquisition statement document, and as a result, the user does not actually see statements related to the acquisition of the target data. Compared to the data acquisition statement document, a data acquisition prompt provided during an actual interaction between the user and the mobile application can ensure that the user sees relevant content, thereby more effectively safeguarding users'right to know. Herein, a data acquisition statement displayed during the actual interaction between the user and the application is referred to as a “runtime data acquisition explicit indication”. In related detection technologies for the explicit indication for data acquisition, detection on the runtime data acquisition explicit indication is often overlooked.

Additionally, the data acquisition statement document has a characteristic of being easily accessible (e.g., it can be easily acquired by accessing to a statement document link of a specified mobile application in an application market), and has a complete sentence structure, facilitating parsing. In contrast, the runtime data acquisition explicit indication in the mobile application is distributed throughout various interactions between the mobile application and the user, which is not easy to acquire. Additionally, the runtime data acquisition explicit indication is often composed of dispersed words or phrases. The fragmented structure makes it challenging to accurately parse the runtime data acquisition explicit indication, and related detection solutions cannot be directly used to detect the runtime data acquisition explicit indication in the mobile application.

In view of this, an embodiment of the present disclosure provides a solution for detecting an explicit indication for data acquisition in an application. In the solution, a computing device may determine that the application performs an action of acquiring target data. Additionally, the computing device may acquire page information on a runtime page in the application. Then, the computing device may generate, based on the page information, an explicit indication recognition result using a language model, the explicit indication recognition result indicates whether the page information includes the explicit indication for data acquisition. Then, the computing device may determine, based on the target data and the explicit indication recognition result, whether the acquisition of the target data meets predetermined requirements.

Through the method, the language model can recognize whether the page information displayed on the runtime page is the explicit indication for data acquisition, thereby reducing error recognition and missed recognition, and then improving the accuracy of recognizing the explicit indication for data acquisition. Additionally, by detecting the data acquisition action in the application, whether the data acquisition action meets the predetermined requirements can be determined based on the explicit indication recognition result of the runtime page, thereby improving the comprehensiveness of detecting the explicit indication for data acquisition.

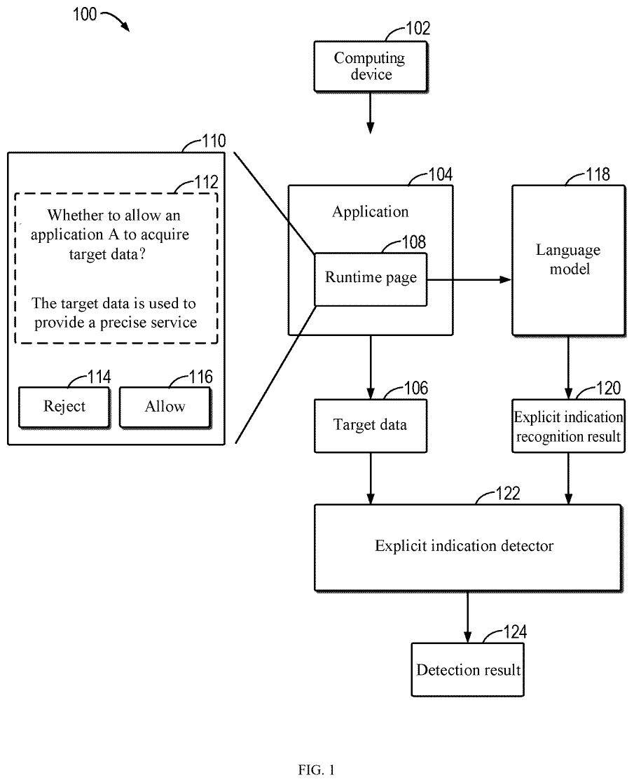

FIG. 1 illustrates a schematic diagram of an example environment 100 where a plurality of embodiments of the present disclosure may be implemented. As shown in FIG. 1, the environment 100 includes a computing device 102, and the computing device 102 may be any device with a computing capability or a processing capability. For example, the computing device 102 may be a local server, a cloud server, a desktop computer, a laptop computer, a tablet computer, etc. In the environment 100, an application 104 is a running application that may run on the computing device 102 or a device other than the computing device 102 (e.g., a user device). The application 104 may be, for example, a content distribution application, a social application, a map application, and a lifestyle service application.

The computing device 102 may simulate user interactions with the application 104 and acquire data associated with the application 104 (e.g., a screenshot, and data transmitted over a network) in an interaction process. In the environment 100, the computing device 102 may determine that the application 104 has an action of acquiring target data 106 in a running process by monitoring the data associated with the application 104. The target data 106 is a specific type of data. When acquiring the specific type of data, the application 104 should meet the predetermined requirements. The predetermined requirements may specify that the application 104 may acquire and use the specific type of data with the user's knowledge or consent. In some embodiments, the computing device 102 may acquire a system interface called by the application 104, and determine whether the system interface is configured to acquire the target data 106. In some embodiments, the computing device 102 may acquire data transmitted by the application 104 over a network, and determine whether the data includes the target data 106.

In the environment 100, the computing device 102 may acquire a runtime page 108 displayed in the application 104, and the runtime page 108 may be any page displayed in the running process of the application 104, which may include a page used to display the explicit indication for data acquisition. In the environment 100, the runtime page 108 may include page information 110, and an example of the page information 110 is shown in FIG. 1. In the example, the page information 110 includes text content 112, a button 114, and a button 116. The text content 112 is used to ask a user whether an application A is allowed to acquire the target data (e.g., the target data 106) and to inform the user of the purpose of acquiring the target data (e.g., to provide a precise service). Both the button 114 and the button 116 are also part of the page information 110 and are used to provide the user with options to allow or reject the application A from acquiring the target data. The computing device 102 may extract the page information 110 from the runtime page 108 by using technologies such as an optical character recognition (OCR) technology.

In the environment 100, after acquiring the page information 110, the computing device may generate, based on the page information 110, an explicit indication recognition result 120, using a language model 118, and the explicit indication recognition result 120 may indicate whether the page information 110 includes the explicit indication for data acquisition. The language model 118 may be a deep learning-based natural language processing model that can understand natural language and generate high-quality coherent texts by learning from massive amounts of text data, and capturing grammatical, semantic, and contextual relationships in the language. The core working principle of the language model 118 is to analyze, based on a transformer architecture, associations between words and sentences in an input text through a self-attention mechanism to recognize a deep structure in the language. For example, the language model 118 may be a large language model (LLM) such as GPT and BERT.

In some embodiments, the computing device 102 may generate a prompt for the language model 118 based on the page information 110. The prompt indicates determining whether the page information includes the explicit indication for data acquisition based on the provided page information. Then, the computing device 102 may generate the explicit indication recognition result 120 by inputting the generated prompt into the language model 118. For example, the explicit indication recognition result 120 may be “Yes” or “No”, where “Yes” indicates that the page information 110 includes the explicit indication for data acquisition, and “No” indicates that the page information 110 does not include the explicit indication for data acquisition. Since the language model 118 has advantages in the aspects of semantic understanding and contextual understanding, even if the content in the page information 110 is composed of the dispersed words or phrases, the language model 118 can still accurately understand the meaning of the page information 110, and output the explicit indication recognition result 120, thereby reducing error recognition and missed recognition.

In the environment 100, the computing device 102 may determine, based on the target data 106 and the explicit indication recognition result 120, whether the action of acquiring the target data 106 meets the predetermined requirements. As shown in FIG. 1, an explicit indication detector 122 may determine a detection result 124 based on the target data 106 and the explicit indication recognition result 120, and the detection result 124 may indicate whether the action of acquiring the target data 106 by the application 104 meets the predetermined requirements. For example, when the computing device 102 detects that the application 104 has the action of acquiring the target data 106 in the running process but does not detect a runtime page where the explicit indication recognition result 120 is “Yes”, it may be determined that the application 104 does not provide a corresponding data acquisition explicit indication to the user when acquiring the target data 106, and therefore the predetermined requirements are not met. If the computing device 102 detects the runtime page where the explicit indication recognition result 120 is “Yes”, whether the explicit indication for data acquisition in the page information 110 is associated with the target data 106, and whether the explicit indication for data acquisition meets the predetermined requirements for the target data 106 may be further determined.

Through the method, the language model 118 can recognize whether the page information 110 displayed on the runtime page 108 is the explicit indication for data acquisition, thereby reducing error recognition and missed recognition, and then improving the accuracy of recognizing the explicit indication for data acquisition. Additionally, by detecting the data acquisition action in the application 104, whether the data acquisition action meets the predetermined requirements can be determined based on the explicit indication recognition result 120 of the runtime page 108, thereby improving the comprehensiveness of detecting the explicit indication for data acquisition.

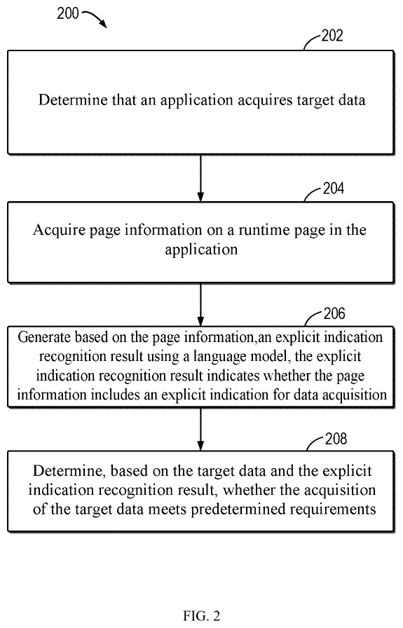

FIG. 2 illustrates a flowchart of a method 200 for detecting an explicit indication for data acquisition in an application according to some embodiments of the present disclosure. The method 200 may be performed by a computing device, such as the computing device 102 in FIG. 1. As shown in FIG. 2, at a block 202, the computing device may determine that the application acquires target data. For example, in the environment 100 shown in FIG. 1, the computing device 102 may simulate user interactions with the application 104 and acquire data associated with the application 104 in an interaction process. The computing device 102 may determine that the application 104 has an action of acquiring the target data 106 in the running process by monitoring the data associated with the application 104. The target data 106 is a specific type of data. When acquiring the specific type of data, the application 104 should meet predetermined requirements. The predetermined requirements may specify that the application 104 may acquire and use the specific type of data with the user's knowledge or consent.

At a block 204, the computing device may acquire page information on a runtime page in the application. For example, in the environment 100 shown in FIG. 1, the computing device 102 may acquire the runtime page 108 displayed in the application 104, and the runtime page 108 may be any page displayed in the running process of the application 104, which may include a page used to display the explicit indication for data acquisition. The computing device 102 may extract the page information 110 from the runtime page 108 by using the technologies such as the optical character recognition (OCR) technology.

At a block 206, the computing device may generate, based on the page information, an explicit indication recognition result using a language model, the explicit indication recognition result indicates whether the page information includes the explicit indication for data acquisition. For example, in the environment 100 shown in FIG. 1, the computing device may generate, based on the page information 110, generate the explicit indication recognition result 120, using the language model 118, and the explicit indication recognition result 120 may indicate whether the page information 110 includes the explicit indication for data acquisition. In some embodiments, the computing device 102 may generate a prompt for the language model 118 based on the page information 110. The prompt indicates determining whether the page information includes the explicit indication for data acquisition based on the provided page information. Then, the computing device 102 may generate the explicit indication recognition result 120 by inputting the generated prompt into the language model 118. For example, the explicit indication recognition result 120 may be “Yes” or “No”, where “Yes” indicates that the page information 110 includes the explicit indication for data acquisition, and “No” indicates that the page information 110 does not include the explicit indication for data acquisition.

At a block 208, the computing device may determine, based on the target data and the explicit indication recognition result, whether the acquisition of the target data meets the predetermined requirements. For example, in the environment 100 shown in FIG. 1, the computing device 102 may determine, based on the target data 106 and the explicit indication recognition result 120, whether the action of acquiring the target data 106 meets the predetermined requirements. For example, when the computing device 102 detects that the application 104 has the action of acquiring the target data 106 in the running process but does not detect a runtime page where the explicit indication recognition result 120 is “Yes”, it may be determined that the application 104 does not provide a corresponding data acquisition explicit indication to the user when acquiring the target data 106, and therefore the predetermined requirements are not met. If the computing device 102 detects the runtime page where the explicit indication recognition result 120 is “Yes”, whether the explicit indication for data acquisition in the page information 110 is associated with the target data 106, and whether the explicit indication for data acquisition meets the predetermined requirements for the target data 106 may be further determined.

Through the method, the language model can recognize whether the page information displayed on the runtime page is the explicit indication for data acquisition, thereby reducing error recognition and missed recognition, and then improving the accuracy of recognizing the explicit indication for data acquisition. Additionally, by detecting the data acquisition action in the application, whether the data acquisition action meets the predetermined requirements can be determined based on the explicit indication recognition result of the runtime page, thereby improving the comprehensiveness of detecting the explicit indication for data acquisition.

In some embodiments, when determining that the application acquires the target data, the computing device may acquire a system interface called by the application, and then it is determined that the application acquires the target data by determining that the system interface is configured to acquire the target data. Alternatively, the computing device may acquire network data sent by the application, and then determine that the application acquires the target data based on determining that the network data includes the target data.

In some embodiments, when acquiring the page information on the runtime page in the application, the computing device may log into the application by logging into a third-party account and using a single sign-on method. Then, the computing device may acquire the page information on the runtime page in the application in a login state.

In some embodiments, when determining that the acquisition of the target data meets the predetermined requirements, the computing device may determine that the page information is associated with the target data in response to the explicit indication recognition result indicating that the page information includes the explicit indication for data acquisition. Then, the computing device may determine acquisition time of the target data and display time of the runtime page. The computing device may determine that the acquisition of the target data does not meet the predetermined requirements in response to the acquisition time of the target data earlier than the display time of the runtime page.

In some embodiments, when determining that the target data is associated with the page information, the computing device may determine a first data category of the target data and a second data category associated with the page information. Then, the computing device may determine semantic relevance between the first data category and the second data category. The semantic relevance indicates whether the first data category and the second data category are semantically similar or have a hyponymy relationship in terms of semantics. Then, the computing device may determine, based on the semantic relevance, that the target data is associated with the page information. In some embodiments, in response to determining that the page information is associated with the target data, the computing device may determine, based on the page information, whether the acquisition of the target data meeting the predetermined requirements, using a second language model.

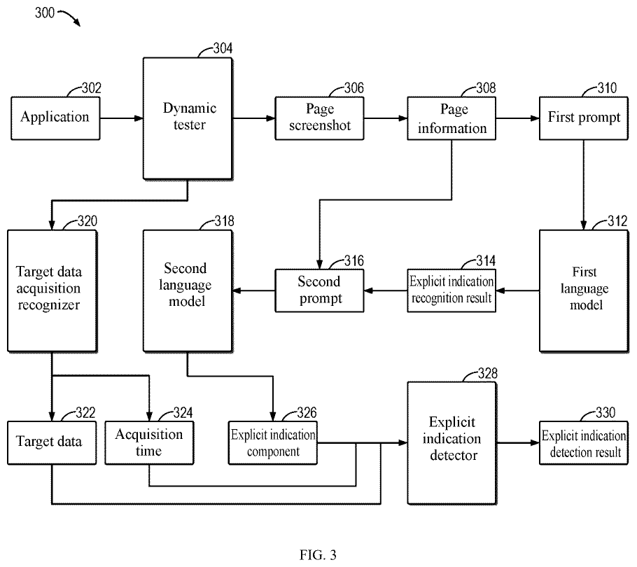

FIG. 3 illustrates a schematic diagram of an architecture of an example system 300 for detecting an explicit indication for data acquisition in an application according to some embodiments of the present disclosure. As shown in FIG. 3, the system 300 includes a dynamic tester 304, a first language model 312, a second language model 318, and an explicit indication detector 328.

The dynamic tester 304 may be configured to achieve automatic login into the application by using a dynamic test technology in conjunction with the single sign-on method, thereby fully triggering a business logic of the tested application in the login state, expanding scenarios where target data acquisition events and data acquisition explicit indication events can be triggered, and then enhancing the comprehensiveness of testing.

A target data acquisition recognizer 320 may be configured to capture an acquisition action of the target data executed by the application by monitoring system interface calling associated with the target data and recognizing data sent by the application over the network.

A language model-based explicit indication analyzer may be composed of the first language model 312 and the second language model 318. The first language model 312 may be configured to detect whether page information on a runtime page includes the explicit indication for data acquisition. The second language model 318 may be configured to extract explicit indication components from the page information on the runtime page (e.g., explicit indication components specified by the predetermined requirements). In this embodiment of the present disclosure, pre-trained language models may be fine-tuned using collected offline data, thereby generating the first language model 312 and the second language model 318. It should be noted that in some embodiments, the first language model 312 and the second language model 318 may be the same language model, which may integrate functions of both the first language model 312 and the second language model 318.

The explicit indication detector 328 may be configured to construct an ontology mapping relationship between target data acquisition actions and runtime data acquisition explicit indications for association. Then, the explicit indication detector 328 may determine whether the runtime data acquisition explicit indication for the target data acquisition action is missing in the tested application according to the association between the target data acquisition actions and the runtime data acquisition explicit indications. Additionally, the explicit indication detector 328 may also determine, based on the association, whether the explicit indication components contained in the explicit indication for data acquisition meet provisions for the explicit indication components in the predetermined requirements.

As shown in FIG. 3, the dynamic tester 304 may simulate user interactions with a tested application 302, so that the system 300 can monitor various target data acquisition actions and runtime data acquisition explicit indications in the application 302. In a mobile application, an account system is widely used to facilitate the management of user-associated information and the provision of services to the user. Therefore, a large number of interactive business logics in the application are presented only after the user logs into an account. Therefore, to more comprehensively and frequently trigger the target data acquisition action in the application and present the runtime page showing the explicit indication for data acquisition, the dynamic tester 304 may automatically achieve the application login and subsequent dynamic tests.

Since different applications may maintain independent account systems, the same account information cannot be universally used to log into the different applications. However, to alleviate the inconvenience caused to the user by managing a plurality of accounts and to facilitate binding with popular application platforms, most applications offer the single sign-on method, and the single sign-on allows the user to log into the different applications using a single account. Therefore, the dynamic tester 304 may perform the dynamic test using the single sign-on. Through the method, the comprehensiveness of detecting the explicit indication for data acquisition can be improved.

After logging into the application, the dynamic tester 304 may automatically simulate the user interactions with the application, and save the page information in the interaction process. For example, the dynamic tester 304 may save a page screenshot 306 of the runtime page in the application, and then may use the technologies such as OCR to extract page information 308 from the page screenshot 306. In some embodiments, in addition to the page screenshot 306, the dynamic tester 304 may also save layout information of the runtime page, and use the layout information to assist in extracting the page information 308 from the page screenshot 306, thereby improving completeness and semantic coherence of the page information 308.

Additionally, in the process of the dynamic test after logging into the application, the target data acquisition recognizer 320 may continuously monitor the target data acquisition action in the application. After detecting the target data acquisition action, the target data acquisition recognizer 320 may acquire target data 322 corresponding to the action and acquisition time 324 of the target data 322. When acquiring the target data, the application often calls the system interface provided by an operating system. Additionally, even though part of the target data is not acquired by calling the system interface, these data may be sent to a server side of the application through the network. Therefore, the target data acquisition recognizer 320 may acquire system interface calls and network transmitted data in the application running process, and respectively determine whether the target data acquisition action exists based on the system interface calls and the network transmitted data. Through the method, the comprehensiveness of detecting the target data acquisition action can be improved.

In some embodiments, the target data acquisition recognizer 320 may acquire a predetermined keyword set that represents the target data. Then, the target data acquisition recognizer 320 may determine, based on hyponymy of words, words semantically similar to keywords in the keyword set, and add these words to the keyword set. For example, the target data acquisition recognizer 320 may determine, using a ConceptNet word database, words semantically similar to the keywords in the keyword set. The ConceptNet word database stores semantic relevance between the words, and the semantic relevance is determined based on semantic similarity between the words and the hyponymy between the words. The target data acquisition recognizer 320 may use the expanded keyword set to determine whether the network transmitted data includes fields that represent the target data. In addition, the target data acquisition recognizer 320 may also use regular expressions to determine data in the network transmitted data that conforms to specific regular expressions (e.g., data conforming to an email format) as the target data, thereby determining the existence of the target data acquisition action in the application. Through the method, the comprehensiveness of detecting the target acquisition action can be improved.

As shown in FIG. 3, after acquiring the page information 308, the system 300 may generate a first prompt 310 based on the page information 308. The first prompt 310 is used to allow the first language model 312 to generate an explicit indication recognition result 314 based on the page information 308, and the explicit indication recognition result 314 indicates whether the page information 308 includes the explicit indication for data acquisition. The first language model 312 may be, for example, the language model 118 in FIG. 1. Since the runtime data acquisition explicit indication has the characteristics of sentence structure fragmentation, component dispersion, etc., a conventional solution for recognizing an explicit indication statement based on a complete sentence structure and sentence semantics has low accuracy. However, since the runtime data acquisition explicit indication is designed to capture user attention and allow the user to notice and read the explicit indication content in time, contextual semantics of the runtime data acquisition explicit indication is usually clear and fixed. Based on this, the system 300 may use overall text information of the runtime page as underlying features and utilize the language model to achieve semantic understanding of the page information, thereby determining whether the page information includes the runtime data acquisition explicit indication. Therefore, the system 300 can reduce false positives and false negatives caused by traditionally determining whether the page information includes the explicit indication for data acquisition through detection on specific data acquisition explicit indication components.

As shown in FIG. 3, after generating the explicit indication recognition result 314, if the explicit indication recognition result 314 indicates that the page information 308 includes the explicit indication for data acquisition, the system 300 may generate a second prompt 316 based on the page information 308, and the second prompt 316 is used to allow the second language model 318 to extract an explicit indication component 326 from the page information 308. For example, in some predetermined requirements, it is stipulated that the explicit indication for data acquisition should include the following explicit indication components: an identity of a data controller initiating a target data processing action (i.e., IC), rights of the user (i.e., UR), a type of processed target data (i.e., TD), a purpose of processing (i.e., PP), a basis for processing the target data (i.e., LB), a storage period of the processed target data (i.e., SP), and a recipient of the processed target data (i.e., ER). Therefore, the second prompt 316 may require the second language model 318 to extract the above explicit indication component from the provided page information, and output an extracted result in a field format, where key-value pairs in a directory correspond to explicit indication components. Additionally, if some explicit indication components are missing from the page information, values of the explicit indication components may be set to null. Through the method, the system 300 can determine, based on the explicit indication component 326, whether the explicit indication for data acquisition in the page information 308 meets the predetermined requirements.

In the system 300, the explicit indication detector 328 may generate an explicit indication detection result 330 based on the target data 322, the acquisition time 324, and the explicit indication component 326, and the explicit indication detection result 330 may indicate whether the explicit indication for data acquisition in the page information 308 meets the predetermined requirements. In some embodiments, the explicit indication detection result 330 may include an explicit indication content detection result, a display time detection result, and a display form detection result. The explicit indication content detection result may indicate whether the explicit indication for data acquisition in the page information 308 includes all explicit indication components in the predetermined requirements (e.g., the above seven explicit indication components). If the explicit indication component 326 lacks some explicit indication components in the predetermined requirements, the explicit indication detection result 330 may indicate that the target data acquisition action does not meet the predetermined requirements or the explicit indication content of the explicit indication for data acquisition does not meet the predetermined requirements.

The display time detection result may indicate whether the explicit indication for data acquisition is provided before or at the same time as the target data acquisition action occurs, that is, whether the display time of the page information 308 is earlier than or the same as the acquisition time 324 of the target data 322. If the display time of the page information 308 is later than the acquisition time 324 of the target data 322, the explicit indication detection result 330 may indicate that the target data acquisition action does not meet the predetermined requirements or the display time of the explicit indication for data acquisition does not meet the predetermined requirements.

The display form detection result may indicate whether the explicit indication component 326 is clearly displayed on the runtime page. If the display of the explicit indication component 326 is not clear, the explicit indication detection result 330 may indicate that the target data acquisition action does not meet the predetermined requirements or the display form of the explicit indication for data acquisition does not meet the predetermined requirements.

Due to the inconsistency in granularity between the target data acquisition action and the explicit indication for data acquisition when representing or describing the target data, it is difficult to directly link the two. For example, when the collection of data A is detected, a corresponding explicit indication expression may be “collecting data B,” where data B is a hypernym of the data A. The difference makes it challenging to directly establish a relationship between the target data acquisition action and the explicit indication components of the explicit indication for data acquisition. However, despite the inconsistency in granularity between the target data acquisition action and the explicit indication for data acquisition in terms of expression, there is often a semantic association between them in the form of hypernyms and hyponyms, which actually reflects a conceptual inclusion relationship between the two different expressions, ranging from a broader extension to a narrower extension.

Based on this, the system 300 may associate the target data acquisition action and the corresponding data acquisition explicit indication by using a semantic association method based on a hyponymy relation. After the association is completed, the explicit indication detector 328 may determine the existence of the target data acquisition action without a corresponding data acquisition explicit indication action, which does not meet the predetermined requirements. Additionally, in the case of the existence of the corresponding data acquisition explicit indication, the explicit indication detector 328 may determine whether the explicit indication for data acquisition lacks necessary explicit indication components based on the explicit indication component 326 generated by the second language model 318, and determine whether quality defects exist by analyzing the display time and content expression of the explicit indication for data acquisition.

In the system 300, since the hypernyms typically have the characteristic of broader or more vague concepts, the occurrence frequency of the hypernyms is high. Based on this, in some embodiments, the system 300 may use a frequency analysis technology to filter expressions of all target data type components (i.e., TD) collected in an explicit indication for data acquisition training set, and determine obtained high-frequency expressions as initial hypernym ontologies. Then, a hyponymy association may be established between the filtered hypernym ontologies and keywords in a target data keyword set. Therefore, the explicit indication detector 328 may associate the target data acquisition action with the corresponding data acquisition explicit indication based on the hyponymy association relationship. Through the method, the association accuracy can be improved.

For the display form, due to the higher occurrence frequency of vague words, the explicit indication detector 328 may use a frequency analysis to filter out the most common expressions of different explicit indication components. Then, whether the most common expressions are vague may be determined through a method for accepting a user input, thereby forming a vague word set. Then, the explicit indication detector 328 may perform a matching operation by using the vague word set. If an expression of the explicit indication component 326 is matched with keywords in the vague word set, it may be determined that the explicit indication component does not meet the predetermined requirements in the display form. For example, if the explicit indication component is a purpose of acquiring the target data (i.e., PP), an example of a vague expression may be “for specific/market/analysis purposes”. If the explicit indication component is the identity of the data controller (i.e., IC), an example of a vague expression may be a “partner” or “strategic partner”. If the explicit indication component is the recipient of the target data (i.e., ER), an example of a vague expression may be a “third-party organization” or “partner”. Through the method, the accuracy of detecting the display form of the explicit indication component can be improved.

In some embodiments, when generating the first prompt for the first language model (e.g., the first prompt 310 in FIG. 3), the computing device may acquire a first task description, and the first task description indicates recognizing whether there is an explicit indication for data acquisition in the provided page information that informs the user that the target data is acquired and is used for a specific purpose. Additionally, the computing device may acquire a first example, which includes a page information example and an explicit indication recognition result example. The computing device may generate the first prompt based on the page information, the first task description, and the first example. Then, the computing device may generate the explicit indication recognition result by inputting the first prompt into the first language model. In some embodiments, the task description further indicates outputting an inference process of the explicit indication recognition result, and the example also includes an inference process example for the explicit indication recognition result example.

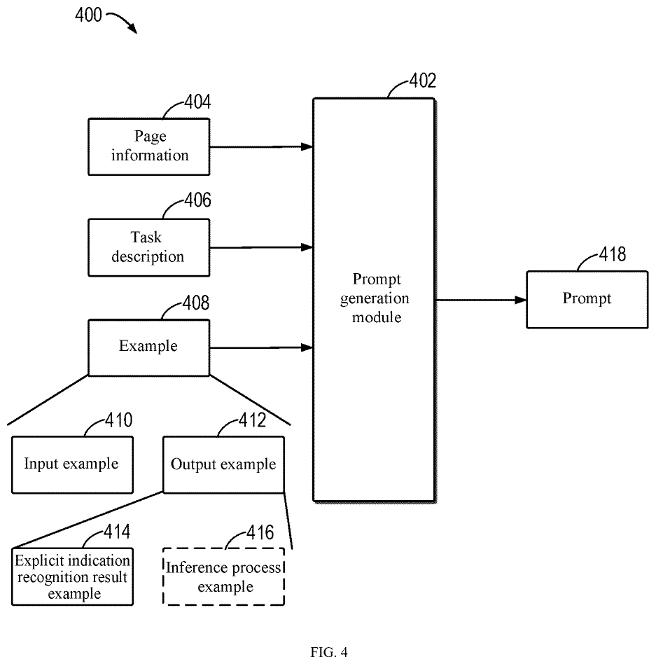

FIG. 4 illustrates a schematic diagram of an example 400 for generating a prompt allowing a language model to output an explicit indication recognition result according to some embodiments of the present disclosure. As shown in FIG. 4, a prompt generation module 402 may acquire page information 404 of a runtime page, a task description 406 instructing the language model to perform a task, and an example 408 including an input example 410 and an output example 412. Then, the prompt generation module 402 may generate a prompt 418 for the language model (e.g., the first language model 312 in FIG. 3) based on the page information 404, the task description 406, and the example 408.

In some embodiments, the task description 406 may include a role description. The role description may inform the language model of its ability to recognize whether there is data acquisition explicit indication semantics in a given text that informs the user that the target data is acquired and serves a specific purpose, and to output whether the given text is a runtime data acquisition explicit indication based on the recognition result. In some embodiments, the task description 406 may also include a skill description. The skill description may specify the output as “Yes” when the given text includes the explicit indication for data acquisition, and the output as “No” when the given text does not include the explicit indication for data acquisition.

In some embodiments, the task description 406 may also require the language model to output a detailed inference process. By forcing the language model to output the detailed inference process, the logicality of the inference process of the language model can be higher, thereby enhancing the accuracy of the output explicit indication recognition result. Additionally, requiring the language model to output the detailed inference process facilitates subsequent diagnosis and recheck of the output explicit indication recognition result. The following illustrates an example of the task description 406.

“#Role

You are a professional expert in recognizing and understanding an explicit indication for data acquisition, can accurately recognize whether a given text contains data acquisition explicit indication semantics that informs a user that target data is acquired and serves a specific purpose, and output whether the given text is a runtime data acquisition explicit indication based on a recognition result, and a corresponding inference process.

#Skill

#Skill 1: Recognize Data acquisition explicit indication semantics
1. After a piece of text is received, whether the text explicitly informs the user that the target data is acquired and serves the specific purpose needs to be analyzed.
2. If the text meets a definition of the explicit indication for data acquisition, “Yes” is output, and an inference process is described in detail.
3. If the text does not meet the definition of the explicit indication for data acquisition, “No” is output, and an inference process is described in detail.

#Skill 2: Explain user explicit indication semantics
1. When the user doubts a determination result on a certain text, it is necessary to explain why the text meets or does not meet the definition of the explicit indication for data acquisition.
2. A detailed inference process is provided to illustrate which parts of the text support your determination.”

As shown in FIG. 4, the example 408 includes the input example 410 and the output example 412, where the output example 412 may include an explicit indication recognition result example 414.In the above embodiment where the task description requires the language model to output the inference process, the output example 412 may also include an inference process example 416. The example 408 can assist the language model in understanding the task to be performed more accurately. Additionally, the example 408 may further limit an output format of the language model, to facilitate automatic processing in a subsequent process. The following illustrates an example of the example 408:

“#Example

Input: We acquire data A to provide you with a service B, and the data A is only used for the service B.

Output: Yes, inference process: the semantics of the text informs the user that the mobile application will acquire the data A to achieve the functionality of the service B, the semantics meets the definition of the explicit indication for data acquisition, further, “the data A is only used for the service B” also informs the user that the target data acquisition action is only used for providing the user with a specific service, and therefore the result is ‘Yes’.

Input: The application requests access to the data A, agree or reject?

Output: Yes, inference process: the semantics of the text informs the user that the mobile application will acquire the data A, and therefore the result is ‘Yes’.

Input: data A, data B, what is your data C?

Output: No, inference process: the semantics of the text does not inform the user of any data processing actions, such as acquisition, by the mobile application or related information, and therefore it is not the explicit indication for data acquisition.”

By generating the prompt 418 based on the task description 406 and the example 408, the accuracy of the explicit indication recognition result generated by the language model for the page information 404 can be improved. Additionally, the example 408 may also limit the output format of the language model, to facilitate automatic processing in the subsequent process. Additionally, by requiring the language model to output the inference process through the prompt 418, the accuracy of the explicit indication recognition result can be further improved, and the subsequent diagnosis and recheck of the explicit indication recognition result are facilitated.

In some embodiments, when generating the second prompt for the second language model (e.g., the second prompt 316 in FIG. 3), the computing device may acquire a second task description, and the second task description indicates determining the explicit indication for data acquisition component included in the provided page information. The computing device may also acquire a second example, which includes a page information example and an explicit indication for data acquisition component example. Then, the computing device may generate the second prompt based on the page information, the second task description, and the second example. The computing device may generate the explicit indication for data acquisition component included in the page information by inputting the second prompt into the second language model. Then, the computing device may determine, based on the explicit indication for data acquisition component, whether the target data meets the predetermined requirements.

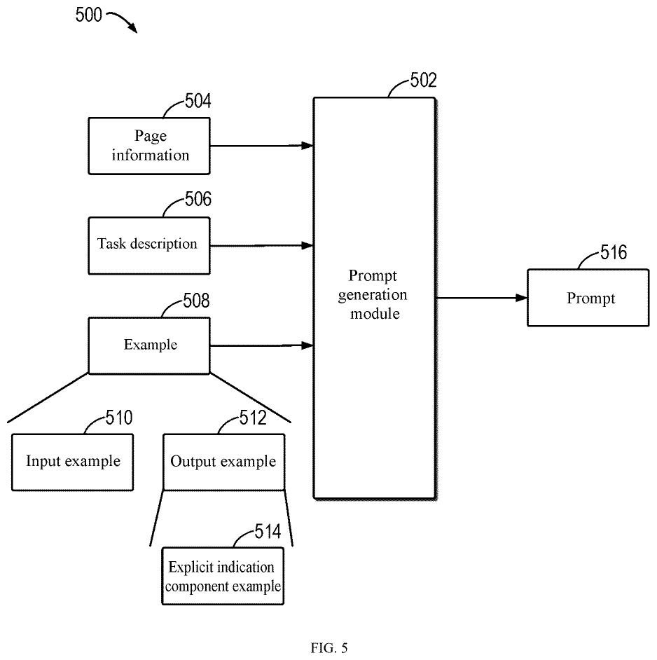

FIG. 5 illustrates a schematic diagram of an example 500 for generating a prompt allowing a language model to output an explicit indication component according to some embodiments of the present disclosure. As shown in FIG. 5, a prompt generation module 502 may acquire page information 504 of a runtime page, a task description 506 instructing the language model to perform a task, and an example 508 including an input example 510 and an output example 512, where the output example 512 includes an explicit indication component example 514. Then, the prompt generation module 502 may generate a prompt 516 for the language model (e.g., the second language model 318 in FIG. 3) based on the page information 504, the task description 506, and the example 508.

In some embodiments, the task description 506 may include a background description, and the background description may include a definition of an explicit indication component. The background description can assist the language model in understanding the meaning of the explicit indication component more accurately, thereby enhancing the accuracy of the output explicit indication component. In some embodiments, the task description 506 may include a role description. The role description may inform the language model of its ability to recognize the existence of the explicit indication component in the given data acquisition explicit indication and extract the explicit indication component for output in a dictionary format. In some embodiments, the task description 506 may also include a skill description. The skill description may inform the language model of its skills in explicit indication component extraction and incomplete information processing. The following illustrates an example of the task description 506.

“#Background

The explicit indication for data acquisition refers to prompt information within the mobile application that informs the user about data processing actions, including acquisition, sharing, storage, etc., taken by the mobile application for the target data. Content components of the explicit indication for data acquisition include the following seven aspects: an identity of a data controller initiating a target data processing action (referred to as IC); rights of a user (referred to as UR); a type of processed target data (referred to as TD); a purpose of processing (referred to as PP); a legal basis for processing the target data (referred to as LB); a storage period of the processed target data (referred to as SP); and recipients of the processed target data (referred to as ER).

#Role

You are a professional analyst for an explicit indication for data acquisition, capable of accurately understanding which explicit indication components exist in a given data acquisition explicit indication and extracting them for output in a dictionary format.

#Skill 1: Extract explicit indication components
1. When an explicit indication for data acquisition text is provided, the explicit indication for data acquisition text needs to be analyzed, and explicit indication components therein are extracted.
2. An extraction result is output in the dictionary format, with specific key-value pairs set as follows:
‘IC’: an identity of a data controller initiating a target data processing action;
‘TD’: a type of processed target data;
‘PP’: a purpose of processing;
‘UR’: rights of a user;
‘LB’: a legal basis for processing the target data;
‘SP’: a storage period of the processed target data; and
‘ER’: recipients of the processed target data.

#Skill 2: Process incomplete information
1. If some explicit indication components are missing from the text, return a null value.”

As shown in FIG. 5, the example 508 includes the input example 510 and the output example 512, where the output example 512 includes the explicit indication component example 514, and a format of the explicit indication component example 514 may correspond to requirements of the task description 506 for the format of the output explicit indication component. The following is an example of the example 508:

Input: The application A acquires the data B to provide you with a service C.

Output: {‘IC’: ‘Application A’, ‘TD’: ‘data B’, ‘PP’: ‘to provide you with a service C’, ‘UR’: None, ‘LB’: None, ‘SP’: None, and ‘ER’: None}

Input: Is the application A allowed to access the data B? This will be used to enhance the experience of the service C. You can revoke this permission at any time. Disallow Allow Home Inbox

Output: {‘IC’: ‘Application A’, ‘TD’: ‘data B’, ‘PP’: ‘to enhance the experience of the service C’, ‘UR’: ‘You can revoke this permission at any time’, ‘LB’: None, ‘SP’: None, and ‘ER’: None}

Input: We need to access your camera to scan QR code.

Output: {‘IC’: ‘We’, ‘TD’: ‘your camera’, ‘PP’: ‘to scan QR code’, ‘UR’: None, ‘LB’: None, ‘SP’: None, and ‘ER’: None}

By generating the prompt 516 based on the task description 506 and the example 508, the accuracy of the explicit indication component generated by the language model can be improved. Additionally, the example 508 may also limit the output format of the language model, to facilitate automatic processing in the subsequent process.

In some embodiments, in a training phase of the first language model (e.g., the first language model 312 in FIG. 3), the computing device may acquire a plurality of pieces of page information from a plurality of applications and a plurality of labels for the plurality of pieces of page information, where each of the plurality of labels indicates whether the corresponding page information from the plurality of pieces of page information includes the explicit indication for data acquisition. Then, the computing device may train a first pre-trained language model based on the plurality of pieces of page information and the plurality of labels, to generate the language model.

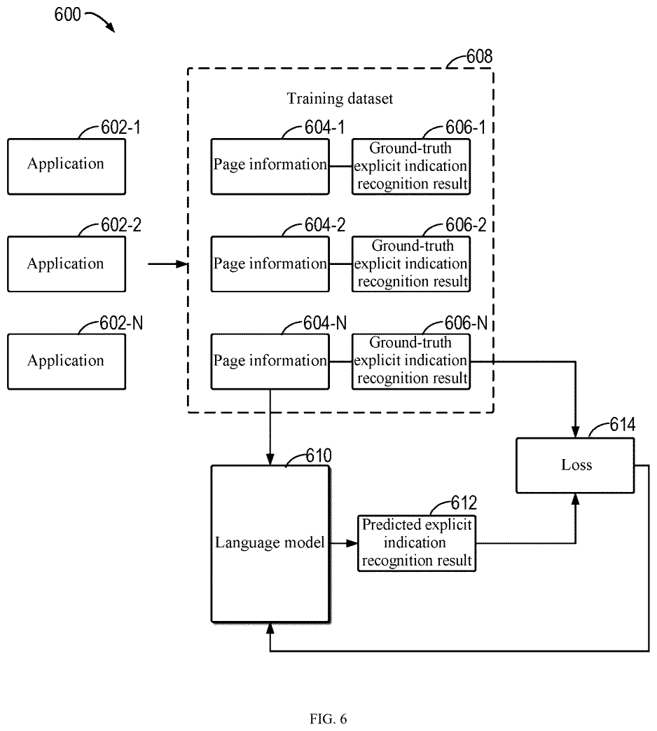

FIG. 6 illustrates a schematic diagram of an example 600 for training a language model for outputting an explicit indication recognition result according to some embodiments of the present disclosure. As shown in FIG. 6, in the example 600, a language model 610 may be a pre-trained language model such as GPT and BERT, which possesses powerful language understanding and generation capabilities through large-scale pre-training. However, the pre-trained language model has a broad range of knowledge and skills but lacks professionalism, accuracy, and task adaptability in specific fields. Therefore, in the example 600, the language model 610 may be fine-tuned based on a training dataset 608, thereby allowing the language model 610 to learn professional knowledge about an explicit indication for data acquisition in the training dataset 608. After being trained, the language model 610 can accurately recognize whether page information includes the explicit indication for data acquisition, and output the explicit indication recognition result. The trained language model 610 may be, for example, the first language model 312 in FIG. 3.

In the example 600, the computing device may acquire the plurality of pieces of page information 604-1, 604-2, . . . , and 604-N (collectively referred to as page information 604) from a plurality of runtime pages of the plurality of applications 602-1, 602-2, . . . , and 602-N (collectively referred to as an applications 602). Then, the computing device may acquire a plurality of ground-truth explicit indication recognition results 606-1, 606-2, . . . , and 606-N (collectively referred to as a ground-truth explicit indication recognition result 606) corresponding to the plurality of pieces of page information 604. For example, the ground-truth explicit indication recognition result 606 may be generated based on the page information 604 through manual annotation. Then, the page information 604 and the ground-truth explicit indication recognition result 606 may form the training dataset 608.

In the example 600, the language model 610 may generate a predicted explicit indication recognition result based on the page information 604. For example, the language model 610 may generate a predicted explicit indication recognition result 612 based on the page information 604-N. Then, the computing device may compare the predicted explicit indication recognition result 612 with the ground-truth explicit indication recognition result 606-N of the page information 604-N, to generate a loss 614. The loss 614 may indicate a difference between the predicted explicit indication result 612 and the ground-truth explicit indication result 606-N. Then, the computing device may fine-tune the language model 610 using the loss 614 to generate the trained language model 610.

By supervised fine-tuning of the pre-trained language model, the semantic understanding capability of the pre-trained language model can be utilized. Additionally, the language model may also learn the professional knowledge about the explicit indication for data acquisition in the training dataset 608, thereby improving the accuracy of explicit indication recognition.

In some embodiments, in a training process of the second language model, the computing device may acquire a plurality of statement documents displayed in a plurality of applications that are used for describing the target data. The computing device may also extract a plurality of data acquisition explicit indication components from the plurality of statement documents. Then, the computing device may train a second pre-trained language model based on the plurality of data acquisition explicit indication components, to generate the second language model.

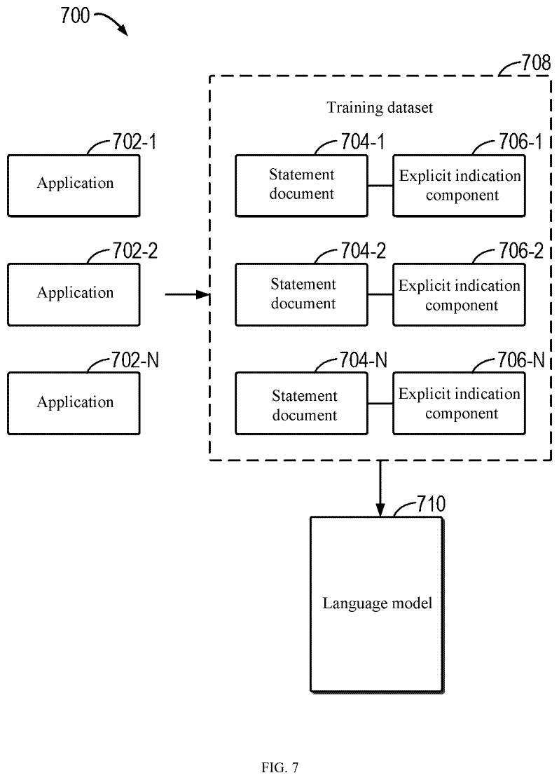

FIG. 7 illustrates a schematic diagram of an example 700 for training a language model for outputting an explicit indication component according to some embodiments of the present disclosure. In a runtime page of an application, the content of an explicit indication for data acquisition is often dispersed. However, semantics of the explicit indication component is often fixed and is kept consistent with semantics of the corresponding content in a statement document for describing target data (e.g., a privacy policy document). For example, a target data type, an acquisition purpose, and other explicit indication components displayed in the runtime page also have corresponding expressions in the statement document, and the explicit indication components and the expressions are kept semantically consistent. Therefore, in the embodiments of the present disclosure, by drawing on explicit indication component corpus from a large number of easily accessible statement documents, through a small-sample learning method, the pre-trained language model can be fine-tuned by transferring knowledge from the statement documents.

In the example 700, a language model 710 is a pre-trained language model, and may be the language model 610 in FIG. 6, or another language model. The computing device may acquire a plurality of statement documents 704-1, 704-2, . . . , and 704-N (collectively referred to as a statement document 704) from a plurality of applications 702-1, 702-2, . . . , and 702-N (collectively referred to as an application 702). Additionally, the computing device may acquire a plurality of pre-identified explicit indication components 706-1, 706-2, . . . , and 706-N (collectively referred to as an explicit indication component 706) from the plurality of statement documents 704. Therefore, the statement document 704 and the pre-identified explicit indication components 706 may form a training dataset 708.

In the example 700, the computing device may fine-tune the language model 710 based on the training dataset 708, thereby allowing the language model 710 to learn knowledge about the explicit indication component 706 in the statement document 704. Through the method, the problem of a lack of the explicit indication component corpus due to the difficulty in acquiring runtime data acquisition explicit indications can be solved.

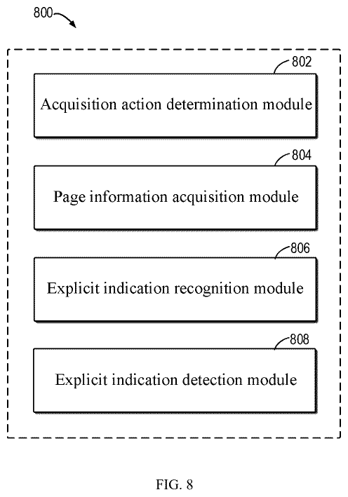

FIG. 8 illustrates a block diagram of an apparatus 800 for detecting an explicit indication for data acquisition in an application according to some embodiments of the present disclosure. As shown in FIG. 8, the apparatus 800 includes an acquisition action determination module 802, configured to determine that the application acquires target data. The apparatus 800 further includes a page information acquisition module 804, configured to acquire page information on a runtime page in the application. The apparatus 800 further includes an explicit indication recognition module 806, configured to generate, based on the page information, an explicit indication recognition result using a language model, the explicit indication recognition result indicates whether the page information includes the explicit indication for data acquisition. Additionally, the apparatus 800 further includes an explicit indication detection module 808, configured to determine, based on the target data and the explicit indication recognition result, whether the acquisition of the target data meets predetermined requirements.

In some embodiments, the acquisition action determination module 802 includes: a system interface acquisition module, configured to acquire a system interface called by the application; and a system interface analysis module, configured to determine that the application acquires the target data by determining that the system interface is configured to acquire the target data, or a network data acquisition module, configured to acquire network data sent by the application; and a network data analysis module, configured to determine that the application acquires the target data based on determining that the network data includes the target data.

In some embodiments, the page information acquisition module 804 includes: a single sign-on module, configured to log into the application by logging into a third-party account and using a single sign-on method; and a page information acquiring submodule, configured to acquire the page information on the runtime page in the application in a login state.

In some embodiments, the explicit indication recognition module 806 includes: a first task description acquisition module, configured to acquire a first task description, where the first task description indicates recognizing whether there is an explicit indication for data acquisition in the provided page information that informs the user that the target data is acquired and is used for a specific purpose; a first example acquisition module, configured to acquire a first example, where the example includes a page information example and an explicit indication recognition result example; a first prompt generation module, configured to generate a first prompt based on the page information, the first task description, and the first example; and a first prompt use module, configured to generate the explicit indication recognition result by inputting the first prompt into the language model.

In some embodiments, the task description further indicates outputting an inference process of the explicit indication recognition result, and the example also includes an inference process example for the explicit indication recognition result example.

In some embodiments, the explicit indication detection module 808 includes: an association determination module, configured to determine that the page information is associated with the target data in response to the explicit indication recognition result indicating that the page information includes the explicit indication for data acquisition; a first time determination module, configured to determine acquisition time of the target data; a second time determination module, configured to determine display time of the runtime page; and a time comparison module, configured to determine that the acquisition of the target data does not meet the predetermined requirements in response to the acquisition time of the target data earlier than the display time of the runtime page.

In some embodiments, the association determination module includes: a first data category determination module, configured to determine a first data category of the target data; a second data category determination module, configured to determine a second data category associated with the page information; a semantic relevance determination module, configured to determine semantic relevance between the first data category and the second data category, where the semantic relevance indicates whether the first data category and the second data category are semantically similar or have a hyponymy relationship in terms of semantics; and a semantic relevance use module, configured to determine, based on the semantic relevance, that the target data is associated with the page information.

In some embodiments, the language model is a first language model. The apparatus 800 further includes: a second language model use module, configured to determine, based on the page information, whether the acquisition of the target data meeting the predetermined requirements, using a second language model in response to determining that the page information is associated with the target data.

In some embodiments, based on the page information, the second language model use module includes: a second task description acquisition module, configured to acquire a second task description, where the second task description indicates determining an explicit indication for data acquisition component included in the provided page information; a second example acquisition module, configured to acquire a second example, which includes a page information example and an explicit indication for data acquisition component example; a second prompt generation module, configured to generate a second prompt based on the page information, the second task description, and the second example; a second prompt use module, configured to generate the explicit indication for data acquisition component included in the page information by inputting the second prompt into the second language model; and an explicit indication component use module, configured to determine, based on the explicit indication for data acquisition component, whether the target data meets the predetermined requirements.

In some embodiments, the explicit indication component use module includes: an explicit indication component analysis module, configured to determine that the acquisition of the target data does not meet the predetermined requirements in response to the explicit indication for data acquisition component lacking explicit indication components stipulated by the predetermined requirements.

In some embodiments, the apparatus 800 further includes: a statement document acquisition module, configured to acquire a plurality of statement documents displayed in a plurality of applications that are used for describing the target data; a statement document use module, configured to extract a plurality of data acquisition explicit indication components from the plurality of statement documents; and a second language model training module, configured to train a second pre-trained language model based on the plurality of data acquisition explicit indication components, to generate the second language model.

In some embodiments, the apparatus 800 further includes: a label acquisition module, configured to acquire a plurality of pieces of page information from a plurality of applications and a plurality of labels for the plurality of pieces of page information, where each of the plurality of labels indicates whether the corresponding page information from the plurality of pieces of page information includes the explicit indication for data acquisition; and a first language model training module, configured to train a first pre-trained language model based on the plurality of pieces of page information and the plurality of labels, to generate the language model.

It should be understood that by using the apparatus 800 in the present disclosure, at least one of the many advantages capable of being implemented in the method or the process described above may be achieved. For example, the language model can recognize whether the page information displayed on the runtime page is the explicit indication for data acquisition, thereby reducing error recognition and missed recognition, and then improving the accuracy of recognizing the explicit indication for data acquisition. Additionally, by detecting the data acquisition action in the application, whether the data acquisition action meets the predetermined requirements can be determined based on the explicit indication recognition result of the runtime page, thereby improving the comprehensiveness of detecting the explicit indication for data acquisition.

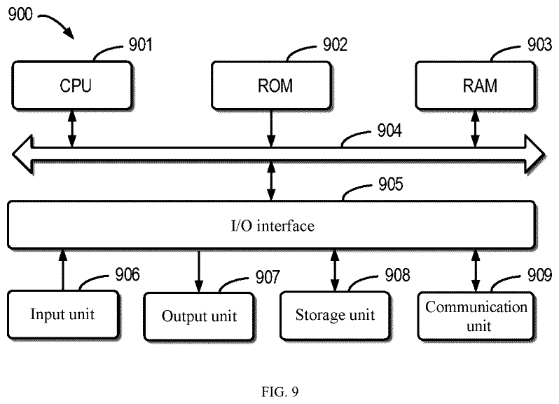

FIG. 9 illustrates a block diagram of a device 900 capable of implementing a plurality of embodiments of the present disclosure. The device 900 may be, for example, the computing device 102 shown in FIG. 1. As shown in FIG. 9, the device 900 includes a central processing unit (CPU) and/or a graphics processing unit (GPU) 901, which may perform various suitable actions and processing according to computer program instructions stored in a read-only memory (ROM) 902 or computer program instructions loaded from a storage unit 908 into a random access memory (RAM) 903. The RAM 903 may also store various programs and data required for the operation of the device 900. The CPU/GPU 901, the ROM 902, and the RAM 903 are connected to one another through a bus 904. An input/output (I/O) interface 905 is also connected to the bus 904. Although not shown in FIG. 9, the device 900 may also include a coprocessor.

A plurality of components in the device 900 are connected to the I/O interface 905, including an input unit 906 such as a keyboard and a mouse; an output unit 907 such as various types of displays and speakers; the storage unit 908 such as a disk and an optical disk; and a communication unit 909 such as a network card, a modem, and a wireless communication transceiver. The communication unit 909 allows the device 900 to exchange information/data with other devices through a computer network such as the Internet, and/or various telecommunication networks.

The various methods or processes described above may be performed by the CPU/GPU 901. For example, in some embodiments, the method may be implemented as a computer software program that is tangibly included in a machine-readable medium, such as the storage unit 908. In some embodiments, part or all of the computer program may be loaded and/or installed onto the device 900 via the ROM 902 and/or the communication unit 909. When the computer program is loaded onto the RAM 903 and executed by the CPU/GPU 901, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., connected through the Internet with the aid of an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or other programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, other programmable data processing apparatus, or other device, such that a series of operating steps are performed on the computer, other programmable data processing apparatus, or other device to produce a computer-implemented process, and accordingly, the instructions executed on the computer, other programmable data processing apparatus, or other device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or improvements to technologies on the market, or to allow other persons of ordinary skill in the art to understand the various embodiments disclosed herein.

I/We claim:

1. A method for detecting an explicit indication for data acquisition in an application, comprising:
determining that the application acquires target data;
acquiring page information on a runtime page in the application;
generating, based on the page information, an explicit indication recognition result using a language model, the explicit indication recognition result indicating whether the page information comprises the explicit indication for data acquisition; and
determining, based on the target data and the explicit indication recognition result, whether the acquisition of the target data meets predetermined requirements.

2. The method according to claim 1, wherein determining that the application acquires the target data comprises:
acquiring a system interface called by the application; and
determining that the application acquires the target data by determining that the system interface is configured to acquire the target data, or,
acquiring network data sent by the application; and
determining that the application acquires the target data based on determining that the network data comprises the target data.

3. The method according to claim 1, wherein acquiring the page information on the runtime page in the application comprises:
logging into the application by logging into a third-party account and using a single sign-on method; and
acquiring the page information on the runtime page in the application in a login state.

4. The method according to claim 1, wherein generating, based on the page information, the explicit indication recognition result using the language model, the explicit indication recognition result comprises:
acquiring a first task description, and the first task description indicating recognizing whether there is an explicit indication for data acquisition in the provided page information that informs a user that the target data is acquired and is used for a specific purpose;
acquiring a first example, and the example comprising a page information example and an explicit indication recognition result example;
generating a first prompt based on the page information, the first task description, and the first example; and
generating the explicit indication recognition result by inputting the first prompt into the first language model.

5. The method according to claim 4, wherein the task description further indicates outputting an inference process of the explicit indication recognition result, and the example also comprises an inference process example for the explicit indication recognition result example.

6. The method according to claim 1, wherein determining, based on the target data and the explicit indication recognition result, whether the acquisition of the target data meets the predetermined requirements comprises:
determining that the page information is associated with the target data in response to the explicit indication recognition result indicating that the page information comprises the explicit indication for data acquisition;
determining acquisition time of the target data;
determining display time of the runtime page; and
determining that the acquisition of the target data does not meet the predetermined requirements in response to the acquisition time of the target data being earlier than the display time of the runtime page.

7. The method according to claim 6, wherein determining that the target data is associated with the page information comprises:
determining a first data category of the target data;
determining a second data category associated with the page information;
determining semantic relevance between the first data category and the second data category, the semantic relevance indicating whether the first data category and the second data category are semantically similar or have a hyponymy relationship in terms of semantics; and
determining, based on the semantic relevance, that the target data is associated with the page information.

8. The method according to claim 6, wherein the language model is a first language model, and the method further comprises:
determining, based on the page information, whether the acquisition of the target data meeting the predetermined requirements, using a second language model in response to determining that the page information is associated with the target data.

9. The method according to claim 8, wherein determining, based on the page information, whether the acquisition of the target data meeting the predetermined requirements, using the second language model comprises:
acquiring a second task description, and the second task description indicating determining an explicit indication for data acquisition component included in the provided page information;
acquiring a second example, which comprises a page information example and an explicit indication for data acquisition component example;
generating a second prompt based on the page information, the second task description, and the second example;
generating the explicit indication for data acquisition component included in the page information by inputting the second prompt into the second language model; and
determining, based on the explicit indication for data acquisition component, whether the target data meets the predetermined requirements.

10. The method according to claim 9, wherein determining, based on the explicit indication for data acquisition component, whether the acquisition of the target data meets the predetermined requirements comprises:
determining that the acquisition of the target data does not meet the predetermined requirements in response to the explicit indication for data acquisition component lacking explicit indication components stipulated by the predetermined requirements.

11. The method according to claim 9, further comprising:
acquiring a plurality of statement documents displayed in a plurality of applications that are used for describing the target data;
extracting a plurality of data acquisition explicit indication components from the plurality of statement documents; and
training a second pre-trained language model based on the plurality of data acquisition explicit indication components, to generate the second language model.

12. The method according to claim 1, further comprising:
acquiring a plurality of pieces of page information from a plurality of applications and a plurality of labels for the plurality of pieces of page information, and each of the plurality of labels indicating whether the corresponding page information from the plurality of pieces of page information comprises the explicit indication for data acquisition; and
training a first pre-trained language model based on the plurality of pieces of page information and the plurality of labels, to generate the language model.

13. An electronic device, comprising:
a processor; and
a memory coupled with the processor, the memory having instructions stored therein, and the instructions, when executed by the processor, causing the electronic device to:
determine that the application acquires target data;
acquire page information on a runtime page in the application;
generate, based on the page information, an explicit indication recognition result using a language model, the explicit indication recognition result indicating whether the page information comprises the explicit indication for data acquisition; and
determine, based on the target data and the explicit indication recognition result, whether the acquisition of the target data meets predetermined requirements.

14. The electronic device according to claim 13, wherein the instructions causing the electronic device to determine that the application acquires the target data further comprise instructions to:
acquire a system interface called by the application; and
determine that the application acquires the target data by determining that the system interface is configured to acquire the target data, or,
acquire network data sent by the application; and
determine that the application acquires the target data based on determining that the network data comprises the target data.

15. The electronic device according to claim 13, wherein the instructions causing the electronic device to acquire the page information on the runtime page in the application further comprise instructions to:
log into the application by logging into a third-party account and using a single sign-on method; and
acquire the page information on the runtime page in the application in a login state.

16. The electronic device according to claim 13, wherein the instructions causing the electronic device to generate, based on the page information, the explicit indication recognition result using the language model, the explicit indication recognition result further comprise instructions to:
acquire a first task description, and the first task description indicating recognizing whether there is an explicit indication for data acquisition in the provided page information that informs a user that the target data is acquired and is used for a specific purpose;
acquire a first example, and the example comprising a page information example and an explicit indication recognition result example;
generate a first prompt based on the page information, the first task description, and the first example; and
generate the explicit indication recognition result by inputting the first prompt into the first language model.

17. The electronic device according to claim 16, wherein the task description further indicates outputting an inference process of the explicit indication recognition result, and the example also comprises an inference process example for the explicit indication recognition result example.

18. The electronic device according to claim 13, wherein the instructions causing the electronic device to determine, based on the target data and the explicit indication recognition result, whether the acquisition of the target data meets the predetermined requirements further comprise instructions to:
determine that the page information is associated with the target data in response to the explicit indication recognition result indicating that the page information comprises the explicit indication for data acquisition;
determine acquisition time of the target data;
determine display time of the runtime page; and
determine that the acquisition of the target data does not meet the predetermined requirements in response to the acquisition time of the target data being earlier than the display time of the runtime page.

19. The electronic device according to claim 18, wherein the instructions causing the electronic device to determine that the target data is associated with the page information further comprise instructions to:
determine a first data category of the target data;
determine a second data category associated with the page information;
determine semantic relevance between the first data category and the second data category, the semantic relevance indicating whether the first data category and the second data category are semantically similar or have a hyponymy relationship in terms of semantics; and
determine, based on the semantic relevance, that the target data is associated with the page information.

20. A computer program product, wherein the computer program product is tangibly stored on a non-transitory computer-readable medium and comprises machine-executable instructions, and the machine-executable instructions, when executed, cause a machine to:
determine that the application acquires target data;
acquire page information on a runtime page in the application;
generate, based on the page information, an explicit indication recognition result using a language model, the explicit indication recognition result indicating whether the page information comprises the explicit indication for data acquisition; and
determine, based on the target data and the explicit indication recognition result, whether the acquisition of the target data meets predetermined requirements.
